(19) United States
(12) Patent Application Publication
(10) Pub. No.: US 2023/0243360 A1
(43) Pub. Date: Aug. 3, 2023

(54) BLOWER AND AIR CONDITIONER

(71) Applicant: Mitsubishi Electric Corporation, Tokyo (JP)

(72) Inventors: Takaya SHIMOKAWA, Tokyo (JP); Hiroki ASO, Tokyo (JP); Naoki TAMURA, Tokyo (JP); Kazuchika TSUCHIDA, Tokyo (JP); Takanori WATANABE, Tokyo (JP); Ryogo TAKAHASHI, Tokyo (JP)

(21) Appl. No.: 17/785,668

(22) PCT Filed: Feb. 25, 2020
(86) PCT No.: PCT/JP2020/007542

§ 371 Date: Jun. 15, 2022

(51) Int. Cl. F04D 25/06; F04D 29/66; H02K 7/14; H02K 1/2746

(52) U.S. Cl. CPC F04D 25/0646; F04D 29/66; H02K 7/14; H02K 1/2746

(57) ABSTRACT

A blower includes a rotor that includes a shaft, a rotor core in an annular shape about at a central axis of the shaft, and permanent magnets attached to the rotor core. The permanent magnets form magnet magnetic poles, portions of the rotor core form virtual magnetic poles, and a number of magnetic poles including the magnet magnetic poles and the virtual magnetic poles is P. The blower includes a stator that surrounds the rotor from outside in a radial direction about the central axis and includes S slots arranged in a circumferential direction about the central axis, and N blades that are attached to the shaft and arranged in the circumferential direction. A combination of the number P of magnetic poles and the number S of slots is one of P=8 and S=9, P=10 and S=9, P=10 and S=12 and P=14 and S=12. The number N of blades is an integer greater than or equal to 2 and less than or equal to 10 excluding integral multiples of P/2.

This application is a U.S. national stage application of International Patent Application No. PCT/JP2020/007542 filed on Feb. 25, 2020, the disclosure of which is incorporated herein by reference.

### TECHNICAL FIELD

The present disclosure relates to a blower and an air conditioner.

### BACKGROUND ART

To reduce noise of a blower, there have been proposed various combinations of the number of blades, the number of magnetic poles of a motor and the number of slots of the motor (see Patent Reference 1, for example).

### PATENT REFERENCE

Patent Reference 1: WO 2015/011892 (paragraphs 0053 to 0054)

In recent years, rotors of the consequent-pole type including magnet magnetic poles and virtual magnetic poles are being developed. In the rotor of the consequent-pole type, various harmonic components are included in surface magnetic flux. In the conventional technology, it is difficult to sufficiently reduce the harmonic components included in the surface magnetic flux of the rotor of the consequent-pole type and the noise of the blower cannot be reduced sufficiently.

### SUMMARY

The present disclosure is made to resolve the above-described problem, and an object of the present disclosure is to sufficiently reduce the noise of a blower including a rotor of the consequent-pole type.

A blower according to the present disclosure includes a rotor that includes a shaft, a rotor core in an annular shape about a central axis of the shaft, and permanent magnets attached to the rotor core. The permanent magnets form magnet magnetic poles, portions of the rotor core form virtual magnetic poles. The number of magnetic poles including the magnet magnetic poles and the virtual magnetic poles is P. The blower includes a stator surrounding the rotor from outside in a radial direction about the central axis and including S slots arranged in a circumferential direction about the central axis, and N blades that are attached to the shaft and arranged in the circumferential direction. The number P of magnetic poles is 8, the number S of slots is 9, and the number N of blades is an integer greater than or equal to 2 and less than or equal to 10 excluding integral multiples of 4, or the number P of magnetic poles is 14, the number S of slots is 12. Alternatively, the number N of blades is an integer greater than or equal to 2 and less than or equal to 10 excluding integral multiples of 7.

According to the present disclosure, it is possible to reduce the harmonic components included in the surface magnetic flux of the rotor and inhibit an increase in vibration due to an exciting force in the radial direction acting on the rotor. Accordingly, the noise of the blower can be reduced.

### BRIEF DESCRIPTION OF THE DRAWINGS

FIG. 1 is a cross-sectional view showing a 10-pole 12-slot motor in a first embodiment.

FIG. 2 is a cross-sectional view showing a rotor of the motor of FIG. 1.

FIG. 3 is a cross-sectional view showing a 10-pole 9-slot motor in the first embodiment.

FIG. 4 is a cross-sectional view showing an 8-pole 9-slot motor in the first embodiment.

FIG. 5 is a cross-sectional view showing a 14-pole 12-slot motor in the first embodiment.

FIG. 6 is a cross-sectional view showing a 14-pole 15-slot motor in the first embodiment.

FIG. 7 is a partially sectional view showing a blower in the first embodiment.

FIG. 8 is a graph showing a fifth order component and a seventh order component of the surface magnetic flux of a rotor of a motor of the consequent-pole type and a motor of a non-consequent-pole type.

FIG. 9 is a graph showing harmonic components of the inductive voltages in 2×M-pole 3×M-slot motors.

FIG. 10 is a graph showing the harmonic components of the inductive voltages in 4×M-pole 3×M-slot motors.

FIG. 11 is a graph showing the harmonic components of the inductive voltages in 8-pole 9-slot, 10-pole 9-slot, 10-pole 12-slot, 14-pole 12-slot and 14-pole 15-slot motors.

FIG. 12 is a graph showing comparison of an inductive voltage waveform between the 10-pole 12-slot motor and an 8-pole 12-slot motor.

FIG. 13 is a schematic diagram for explaining the exciting force in the radial direction acting on the 10-pole 12-slot motor.

FIG. 14 is a schematic diagram for explaining the exciting force in the radial direction acting on the 10-pole 9-slot motor.

FIG. 15 is a schematic diagram for explaining the exciting force in the radial direction acting on the 8-pole 9-slot motor.

FIG. 16 is a schematic diagram for explaining the exciting force in the radial direction acting on the 8-pole 12-slot motor.

FIG. 17 is a schematic diagram for explaining the exciting force in the radial direction acting on a 10-pole 15-slot motor.

FIG. 18 is a graph showing frequency components of the exciting force in the radial direction in the motor of the consequent-pole type and the motor of the non-consequent-pole type.

FIG. 19 is a graph showing a relationship between the number of blades and a maximum width of each of the blades.

FIG. 20 is a schematic diagram showing a fan unit in the first embodiment including two blades.

FIG. 21 is a schematic diagram showing a fan unit in the first embodiment including three blades.

FIG. 22 is a schematic diagram showing a fan unit in the first embodiment including four blades.

FIG. 23 is a schematic diagram showing an air conditioner in the first embodiment.

### DETAILED DESCRIPTION

### First Embodiment

### Motor

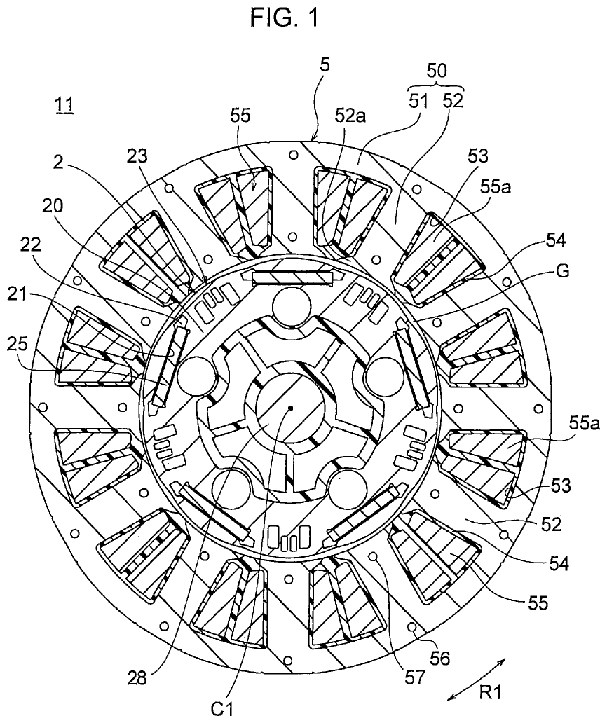

FIG. 1 is a cross-sectional view showing a motor 11 in a first embodiment. The motor 11 includes a rotor 2 that is rotatable and a stator 5 in an annular shape provided to surround the rotor 2. Between the stator 5 and the rotor 2, an air gap G of 0.4 mm, for example, is formed.

In the following description, an axis specifying a rotation center of the rotor 2, namely, a central axis of a shaft 28 which will be described later, is represented as an axis C1. A direction of the axis C1 is referred to as an “axial direction”. A circumferential direction about the axis C1 is referred to as a “circumferential direction” and is indicated by an arrow R1 in FIG. 1 and the like. A radial direction about the axis C1 is referred to as a “radial direction”. Incidentally, FIG. 1 is a cross-sectional view of the rotor 2 in a plane orthogonal to the axis C1.

### Stator

The stator 5 includes a stator core 50 and a coil 55 wound on the stator core 50. The stator core 50 is formed by stacking a plurality of steel sheets in the axial direction and fixing the steel sheets together by means of crimping or the like. The steel sheets are electromagnetic steel sheets, for example. The sheet thickness of each steel sheet is 0.2 mm to 0.5 mm, for example.

The stator core 50 includes a yoke 51 in an annular shape about the axis C1 and a plurality of teeth 52 extending inward in the radial direction from the yoke 51. The teeth 52 are arranged at equal intervals in the circumferential direction. The number of teeth 52 is 12. Between teeth 52 adjoining each other, a slot 53 as a space accommodating the coil 55 is formed. The number of slots 53 is 12,which is the same as the number of teeth 52.

A width in the circumferential direction of a tip end portion 52a on an inner side of the tooth 52 in the radial direction is wider than the other portions of the tooth 52. The tip end portion 52a of the tooth 52 faces an outer periphery of the rotor 2 via the above described air gap G.

The stator core 50 is provided with an insulator 54 as an insulation portion. The insulator 54 is formed of an insulating resin such as polybutylene terephthalate (PBT), polyphenylene sulfide (PPS), liquid crystal polymer (LCP) or polyethylene terephthalate (PET), for example.

The insulator 54 is formed by integral molding of the resin together with the stator core 50 or by attaching a resin molded body, which is molded as a separate component, to the stator core 50. The insulator 54 is disposed between the stator core 50 and the coil 55 and insulates the stator core 50 and the coil 55 from each other.

The coil 55 is wound around the teeth 52 via the insulator 54. The coil 55 is formed of copper or aluminum. The coil 55 is wound around each tooth 52 by concentrated winding.

In the coil 55, a portion wound around each tooth 52 is referred to as a winding portion 55a. The coil 55 is a three-phase coil and includes U-phase winding portions 55a, V-phase winding portions 55a and W-phase winding portions 55a.

### Rotor

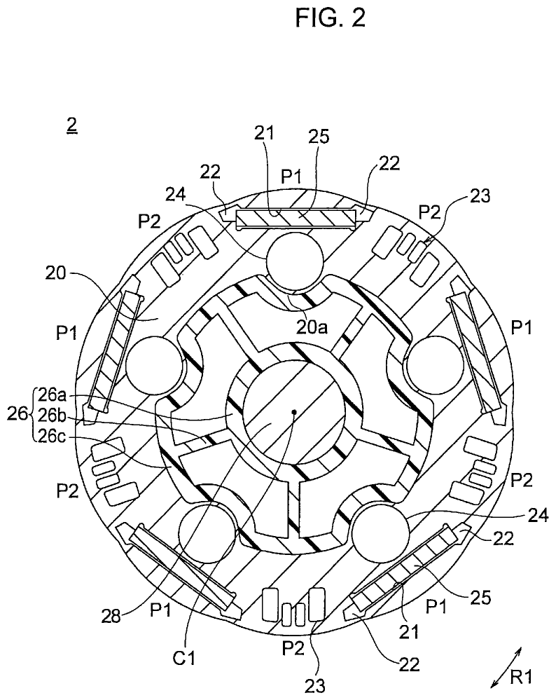

FIG. 2 is a cross-sectional view showing the rotor 2. As shown in FIG. 2, the rotor 2 includes a shaft 28 as a rotary shaft and a rotor core 20 in an annular shape provided outside the shaft 28 in the radial direction.

The rotor core 20 is formed by stacking a plurality of steel sheets in the axial direction and fixing the steel sheets together by means of crimping or the like. The steel sheets are electromagnetic steel sheets, for example. The sheet thickness of each steel sheet is 0.2 mm to 0.5 mm, for example.

The rotor core 20 has a plurality of magnet insertion holes 21. The magnet insertion holes 21 are arranged at equal intervals in the circumferential direction and at the same distance from the axis C1. The number of magnet insertion holes 21 is five.

The magnet insertion hole 21 extends linearly in a direction orthogonal to a straight line in the radial direction (magnetic pole center line) passing through a center in the circumferential direction of the magnet insertion hole 21. However, the magnet insertion hole 21 is not limited to such a shape but may also extend in a V-shape, for example.

On each side of the magnet insertion hole 21 in the circumferential direction, a flux barrier 22 as a hole portion is formed. A core portion between the flux barrier 22 and the outer periphery of the rotor core 20 is formed as a thin-wall portion. To inhibit leakage flux between adjoining magnetic poles, the thickness of the thin-wall portion is desirably the same as the sheet thickness of the steel sheet of the rotor core 20.

In each magnet insertion hole 21, a permanent magnet 25 in the form of a flat plate is inserted. A cross-sectional shape of the permanent magnet 25 orthogonal to the axial direction is a rectangular shape. The permanent magnet 25 is formed of, for example, a rare-earth magnet containing neodymium (Nd), iron (Fe) and boron (B), a rare-earth magnet containing samarium (Sm), iron and nitrogen (N), or a ferrite magnet.

The five permanent magnets 25 have the same magnetic poles (for example, north poles) on their outer sides in the radial direction. In the rotor core 20, magnetic poles (for example, south poles) opposite to the above described magnetic poles are formed each between the permanent magnets 25 adjoining each other in the circumferential direction.

Therefore, the rotor 2 includes five magnet magnetic poles P1 formed by the permanent magnets 25 and five virtual magnetic poles P2 formed by the rotor core 20. Such a configuration is referred to as the consequent-pole type. In the following description, a simple term “magnetic pole” means either the magnet magnetic pole P1 or the virtual magnetic pole P2. The number P of magnetic poles of the rotor 2 is 10.

The center of each of the magnet magnetic pole P1 and the virtual magnetic pole P2 in the circumferential direction is a pole center. The outer periphery of the rotor core 20 has a so-called petal circle shape in a cross section orthogonal to the axial direction. More specifically, the outer periphery of the rotor core 20 has a shape such that its outer diameter is the maximum at the pole center of each magnetic pole P1, P2 and is the minimum at each pole boundary, and extends in an arc shape between the pole center and the pole boundary. However, the outer periphery of the rotor core 20 is not limited to the petal circle shape but may also have a circular shape.

While one permanent magnet 25 is disposed in each magnet insertion hole 21 in this example, two or more permanent magnets 25 may be disposed in each magnet insertion hole 21. Further, it is also possible that the magnet magnetic poles P1 are south poles and the virtual magnetic poles P2 are north poles.

Between the shaft 28 and the rotor core 20, a resin portion 26 which is nonmagnetic is provided. The resin portion 26 connects the shaft 28 and the rotor core 20 to each other. The resin portion 26 is formed of a thermoplastic resin such as PBT, for example.

The resin portion 26 includes an inner cylinder portion 26a in an annular shape contacting an outer periphery of the shaft 28, an outer cylinder portion 26c in an annular shape contacting an inner periphery of the rotor core 20, and a plurality of ribs 26b connecting the inner cylinder portion 26a and the outer cylinder portion 26c to each other.

The inner cylinder portion 26a of the resin portion 26 is penetrated by the shaft 28 in the axial direction. The ribs 26b are arranged at equal intervals in the circumferential direction and radially extend outward in the radial direction from the inner cylinder portion 26a. The number of ribs 26b is half the number P of magnetic poles, and a position in the circumferential direction of each rib 26b coincides with the pole center of the virtual magnetic pole P2. However, the number and the arrangement of the ribs 26b are not limited to the examples described here.

The rotor core 20 includes at least one slit 23 extending in the radial direction at each virtual magnetic pole P2. The slit 23 has a function of rectifying the flow of magnetic flux passing through the virtual magnetic pole P2. In this example, each virtual magnetic pole P2 is provided with four slits 23 which are symmetrically with respect to the pole center. However, the number of slits 23 may be any number. Further, it is not necessary to form the slits 23 at the virtual magnetic pole P2.

The rotor core 20 includes a cavity portion 24 in a circular shape on an inner side of each magnet insertion hole 21 in the radial direction. On the inner periphery of the rotor core 20, a projection portion 20a projecting inward in the radial direction is formed at a portion where each cavity portion 24 is formed. The projection portions 20a function as rotation stoppers for stopping rotation of the rotor core 20 with respect to the resin portion 26. However, it is not necessary to form the projection portions 20a on the inner periphery of the rotor core 20.

Incidentally, while the resin portion 26 is provided between the rotor core 20 and the shaft 28 in this example, it is also possible to fit the shaft 28 into a central hole of the rotor core 20 without providing the resin portion 26.

In the motor 11 described above, the number P of magnetic poles of the rotor 2 is 10 and the number S of slots is 12. Namely, the motor 11 is a 10-pole 12-slot motor.

The motor in this first embodiment is not limited to the 10-pole 12-slot motor 11. In the following description, a 10-pole 9-slot motor 12, an 8-pole 9-slot motor 13, a 14-pole 12-slot motor 14 and a 14-pole 15-slot motor 15 will be described in turn.

### 10-Pole 9-Slot Motor

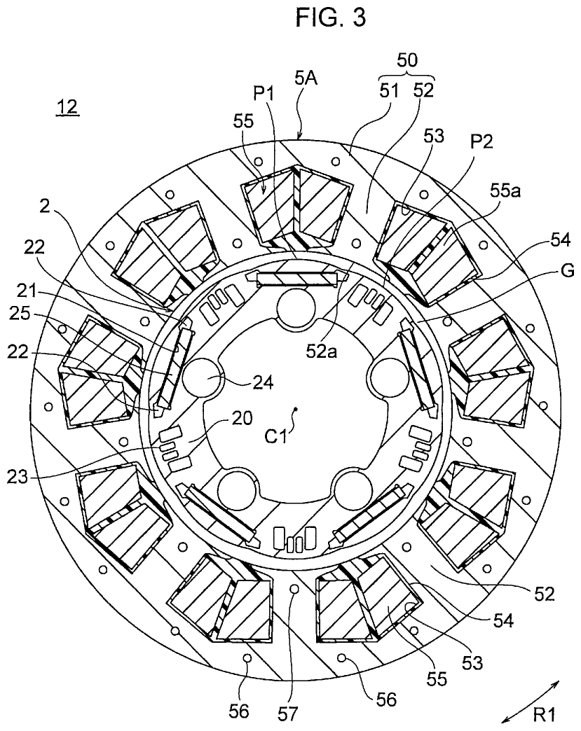

FIG. 3 is a cross-sectional view showing the 10-pole 9-slot motor 12 in the first embodiment. In the motor 12, the number P of magnetic poles is 10 and the number S of slots is 9. The motor 12 includes a rotor 2 and a stator 5A. The rotor 2 is configured in the same way as the rotor 2 (FIG. 1) of the motor 11. The stator 5A differs from the stator 5 (FIG. 1) of the motor 11 in the number S of slots.

The stator 5A includes a stator core 50 and a coil 55 wound on the stator core 50. The stator core 50 includes a yoke 51 in an annular shape and a plurality of teeth 52 extending inward in the radial direction from the yoke 51. The coil 55 is wound around the teeth 52 via an insulator 54.

Between teeth 52 adjoining each other, a slot 53 as a space accommodating the coil 55 is formed. The number of teeth 52 is 9, and thus the number S of slots is 9. Except for the number S of slots, the stator 5A is configured in the same way as the stator 5 (FIG. 1) of the motor 11.

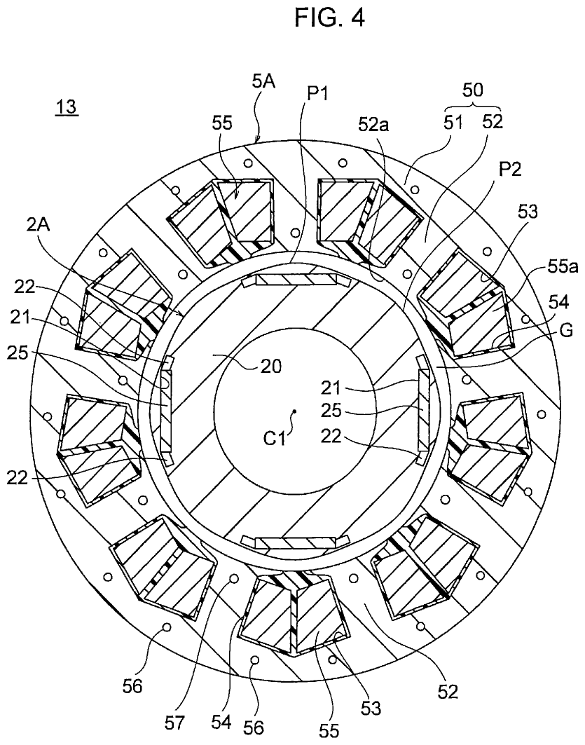

Incidentally, although illustration is omitted in FIG. 3, it is possible to either attach the shaft 28 to the inner periphery of the rotor core 20 of the rotor 2 via the resin portion 26 (FIG. 2) or fit the shaft 28 into the inner periphery of the rotor core 20 of the rotor 2 without providing the resin portion 26. The same goes for the motor 13 to the motor 15 (FIG. 4 to FIG. 6) which will be described below.

### 8-Pole 9-Slot Motor

FIG. 4 is a cross-sectional view showing the 8-pole 9-slot motor 13 in the first embodiment. In the motor 13, the number P of magnetic poles is 8 and the number S of slots is 9. The motor 13 includes a rotor 2A and a stator 5A. The rotor 2A differs from the rotor 2 (FIG. 1) of the motor 11 in the number P of magnetic poles. The stator 5A is configured in the same way as the stator 5A (FIG. 3) of the motor 12.

The rotor 2A includes a rotor core 20, and the rotor core 20 includes a plurality of magnet insertion holes 21. The magnet insertion holes 21 are arranged at equal intervals in the circumferential direction and at the same distance from the axis C1. The number of magnet insertion holes 21 is 4. The flux barrier 22 is formed on each side of the magnet insertion hole 21 in the circumferential direction.

A permanent magnet 25 is inserted in each magnet insertion hole 21. The rotor 2A includes four magnet magnetic poles P1 formed by the permanent magnets 25 and four virtual magnetic poles P2 formed by the rotor core 20. Namely, the number P of magnetic poles of the rotor 2A is 8. Except for the number P of magnetic poles, the rotor 2A is configured in the same way as the rotor 2 (FIG. 2) of the motor 11.

### 14-Pole 12-Slot Motor

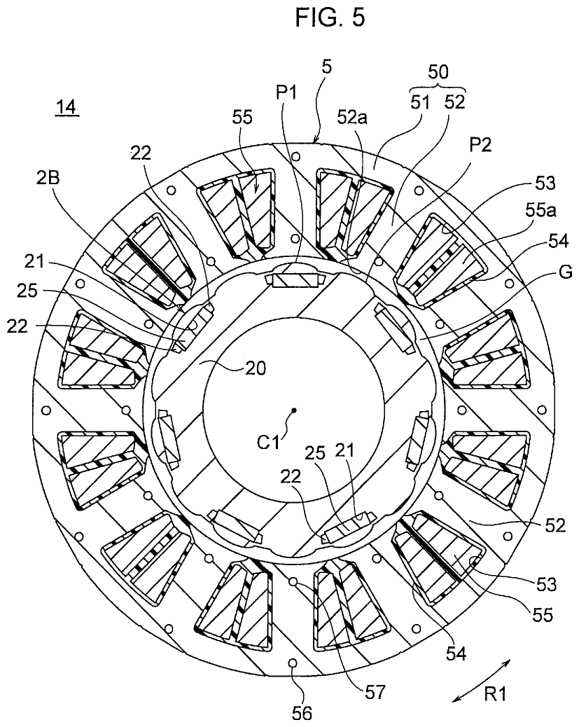

FIG. 5 is a cross-sectional view showing the 14-pole 12-slot motor 14 in the first embodiment. In the motor 14, the number P of magnetic poles is 14 and the number S of slots is 12. The motor 14 includes a rotor 2B and a stator 5. The rotor 2B differs from the rotor 2 (FIG. 1) of the motor 11 in the number P of magnetic poles. The stator 5 is configured in the same way as the stator 5 (FIG. 1) of the motor 11.

The rotor 2B includes a rotor core 20, and the rotor core 20 includes a plurality of magnet insertion holes 21. The magnet insertion holes 21 are arranged at equal intervals in the circumferential direction and at the same distance from the axis C1. The number of magnet insertion holes 21 is 7. The flux barrier 22 is formed on each side of the magnet insertion hole 21 in the circumferential direction.

A permanent magnet 25 is inserted in each magnet insertion hole 21. The rotor 2B includes seven magnet magnetic poles P1 formed by the permanent magnets 25 and seven virtual magnetic poles P2 formed by the rotor core 20. Namely, the number P of magnetic poles of the rotor 2B is 14. Except for the number P of magnetic poles, the rotor 2B is configured in the same way as the rotor 2 (FIG. 2) of the motor 11.

### 14-Pole 15-Slot Motor

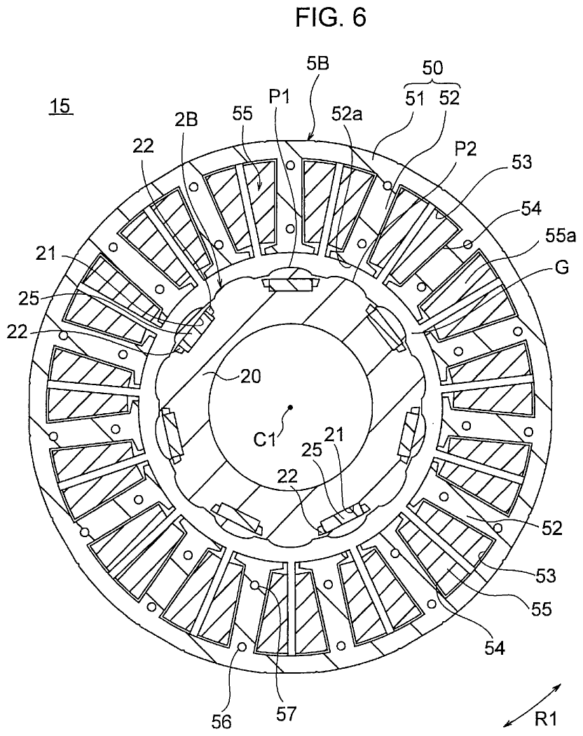

FIG. 6 is a cross-sectional view showing the 14-pole 15-slot motor 15 in the first embodiment. In the motor 15, the number P of magnetic poles is 14 and the number S of slots is 15. The motor 15 includes a rotor 2B and a stator 5B. The rotor 2B is configured in the same way as the rotor 2B (FIG. 5) of the motor 14. The stator 5B differs from the stator 5 (FIG. 1) of the motor 11 in the number S of slots.

The stator 5B includes a stator core 50 and a coil 55 wound on the stator core 50. The stator core 50 includes a yoke 51 in an annular shape and a plurality of teeth 52 extending inward in the radial direction from the yoke 51. The coil 55 is wound around the teeth 52 via an insulator 54.

Between teeth 52 adjoining each other, a slot 53 as a space accommodating the coil 55 is formed. The number of teeth 52 is 15, and thus the number S of slots is 15. Except for the number S of slots, the stator 5B is configured in the same way as the stator 5 (FIG. 1) of the motor 11.

The 10-pole 12-slot motor 11 (FIGS. 1 and 2), the 10-pole 9-slot motor 12 (FIG. 3), the 8-pole 9-slot motor 13 (FIG. 4), the 14-pole 12-slot motor 14 (FIG. 5) and the 14-pole 15-slot motor 15 (FIG. 6) described above are referred to collectively as “motors 10”.

### Blower

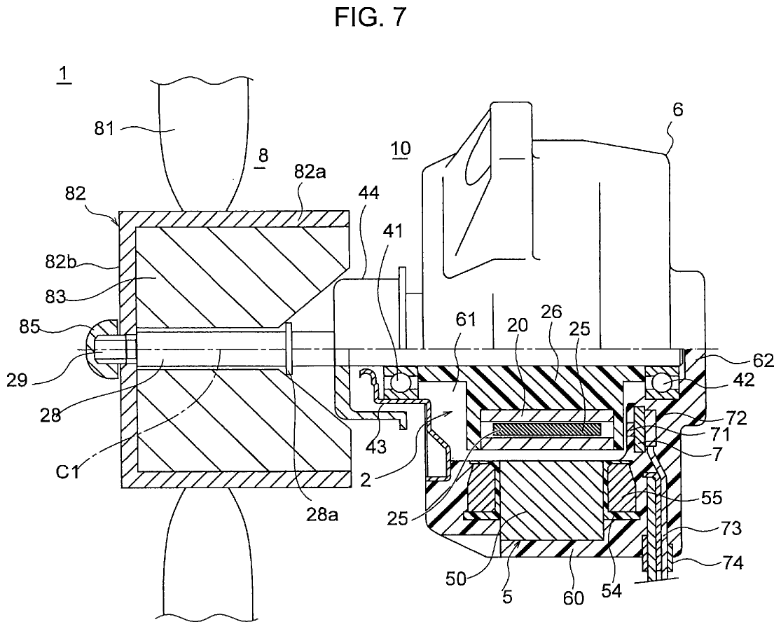

Next, a blower 1 employing the motor 10 will be described. FIG. 7 is a vertical sectional view showing the blower 1 including the motor 10. The motor 10 can be any one of the motors 11 to 15 described above.

The blower 1 includes the motor 10 and a fan unit 8 rotated by the motor 10. The fan unit 8 is fixed to the shaft 28 of the motor 10.

The motor 10 includes a mold resin portion 60 that surrounds the stator 5 from outside in the radial direction. A mold stator 6 is formed by the stator 5 and the mold resin portion 60. The mold resin portion 60 is formed of a thermosetting resin such as BMC (Bulk Molding Compound).

The mold resin portion 60 has an opening portion 61 on one side in the axial direction (left side in FIG. 7) and a bearing support portion 62 on the other side in the axial direction. The rotor 2 of the motor 10 is inserted into a hollow portion in the mold stator 6 through the opening portion 61.

The shaft 28 projects in the axial direction from the opening portion 61 of the mold stator 6. The fan unit 8 is attached to a tip end portion of the shaft 28. Therefore, the projecting side (left side in FIG. 7) of the shaft 28 is referred to as a “load side”, and the opposite side is referred to as a “counter-load side”.

The fan unit 8 includes a hub 82 in a bottomed cylindrical shape attached to the shaft 28 and a plurality of blades 81 provided on an outer periphery of the hub 82. The hub 82 includes a cylindrical portion 82a centering at the axis C1, a disk portion 82b disposed at an end of the cylindrical portion 82a in the axial direction, and a plurality of ribs 83 formed on an inner peripheral side of the cylindrical portion 82a.

The disk portion 82b of the hub 82 has a through hole through which a screw portion 29 passes. The screw portion 29 is formed at the tip end portion of the shaft 28. The plurality of ribs 83 on the inner peripheral side of the cylindrical portion 82a are formed at equal intervals in the circumferential direction. Each rib 83 makes contact with a ring 28a attached to the shaft 28. The hub 82 is fixed to the shaft 28 by screwing a fixation screw 85 onto the screw portion 29 of the shaft 28.

The blades 81 are provided on the outer periphery of the hub 82 at equal intervals in the circumferential direction. The number N of blades 81 will be described later.

A bracket 43 made of metal is attached to the opening portion 61 of the mold resin portion 60. The bracket 43 is formed of a metal having electrical conductivity such as a galvanized steel sheet. A bearing 41 as one of bearings supporting the shaft 28 is held by the bracket 43.

A cap 44 is attached to the outside of the bracket 43. The cap 44 prevents entry of water or the like into the bearing 41. The other bearing 42 supporting the shaft 28 is held by the bearing support portion 62 of the mold resin portion 60.

In the mold resin portion 60, a circuit board 7 is held on the counter-load side of the stator 5. The circuit board 7 is a printed circuit board on which a drive circuit 72 including power transistors or the like for driving the motor 10 are mounted, and lead wires 73 are wired on the circuit board 7.

The lead wires 73 of the circuit board 7 are drawn out to the outside of the motor 10 via a lead wire outlet component 74 attached to an outer peripheral portion of the mold resin portion 60. A magnetic sensor 71 for detecting a rotational position of the rotor 2 may be provided on a surface of the circuit board 7 facing the stator 5.

While the stator 5 is covered with the mold resin portion 60 in this example, it is also possible to cover the stator 5 with a housing made of metal instead of the mold resin portion 60.

### Function of Reducing Harmonic Components of Inductive Voltage

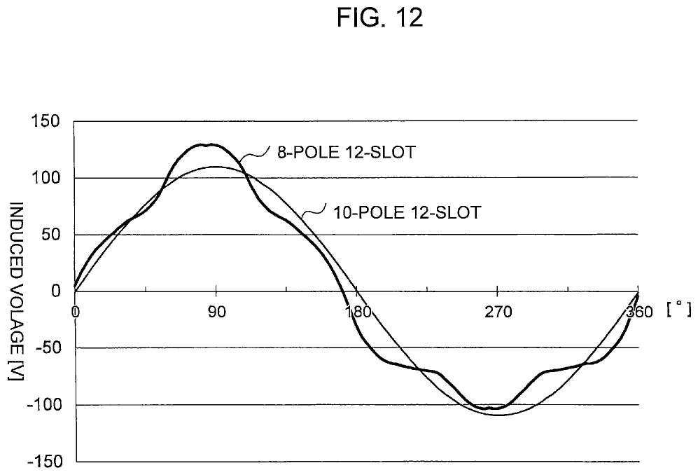

Next, a function of reducing harmonic components of inductive voltage will be described. Magnetic flux emitted from a surface of the rotor 2 has a sinusoidal distribution as shown in FIG. 12 which will be described later, and may include harmonic components. In the coil 55 of the stator 5, a voltage (referred to as an inductive voltage) is induced by the magnetic flux emitted from the rotor 2. If harmonic components are included in the inductive voltage waveform, the harmonic components may cause noise.

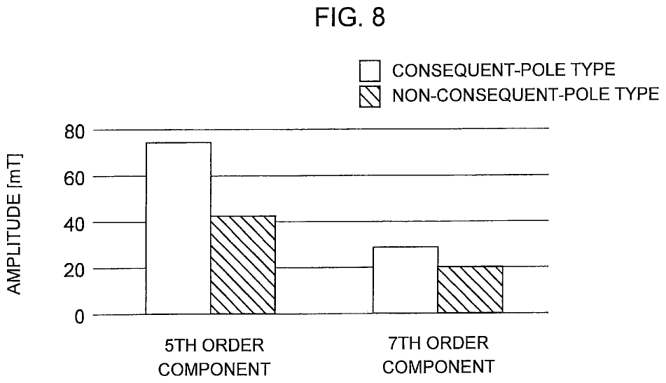

FIG. 8 is a graph showing a result of FFT (Fast Fourier Transform) analysis of the surface magnetic flux of the rotor of the consequent-pole type and the rotor of the non-consequent-pole type. In this example, in the surface magnetic flux of each rotor, a fifth order component and a seventh order component having the greatest influence on the noise are shown. Incidentally, the 360-degree cycle of the electrical angle is regarded as a first order.

From FIG. 8, it is understood that the surface magnetic flux of the rotor 2 of the consequent-pole type includes more fifth order component and more seventh order component as compared to the surface magnetic flux of the rotor of the non-consequent-pole type. This is because the rotor 2 of the consequent-pole type includes the magnet magnetic poles P1 and the virtual magnetic poles P2, and these magnetic poles P1 and P2 are asymmetric.

On the other hand, not all the harmonic components of the surface magnetic flux of the rotor 2 are reflected in the inductive voltage, and the harmonic components of the inductive voltage are reduced according to the number P of magnetic poles and the number S of slots.

Hereinafter, a description will be given of the change in the harmonic components of the inductive voltage when the number P of magnetic poles and the number S of slots are varied.

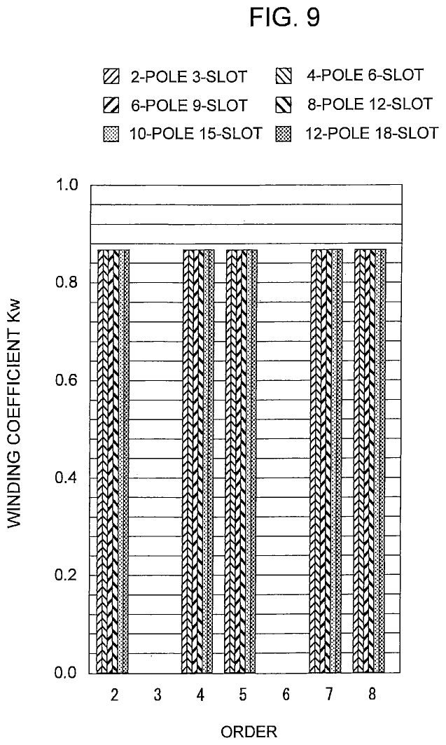

FIG. 9 is a graph showing the harmonic components of the inductive voltage in 2×M-pole 3×M-slot motors (M: natural number) of the consequent-pole type. Specifically, FIG. 9 shows the harmonic components of the inductive voltage in 2-pole 3-slot, 4-pole 6-slot, 6-pole 9-slot, 8-pole 12-slot, 10-pole 15-slot and 12-pole 18-slot motors.

The harmonic components are evaluated in terms of a winding coefficient Kw. The winding coefficient Kw is an index indicating how effectively the magnetic flux from the rotor 2 links with the stator 5. The winding coefficient Kw is obtained as the product of a short pitch winding coefficient Kp and a distributed winding coefficient Kd.

The short pitch winding coefficient Kp is represented by the following expression (1). The distributed winding coefficient Kd is represented by the following expression (2).

Kp=sin(K×β×π/2) (1)

Kd=sin(K×6)/(q×sin(K×π/6N)) (2)

The character β represents a winding pitch relative to a magnetic pole pitch. The character K represents the order. The character q represents a slot number per pole per phase.

For example, the value of the second order winding coefficient Kw is the value of the winding coefficient Kw obtained by substituting K=2 into the above expressions (1) and (2). A smaller value of the winding coefficient Kw means that the corresponding harmonic component is reduced more.

As shown in FIG. 9, in the 2×M-pole 3×M-slot motors, the winding coefficients Kw of the second, fourth, fifth, seventh and eighth order components are all great and are the same value. From this result, it is understood that the harmonic components of the inductive voltage are not reduced in the 2×M-pole 3×M-slot motors irrespective of the value of M.

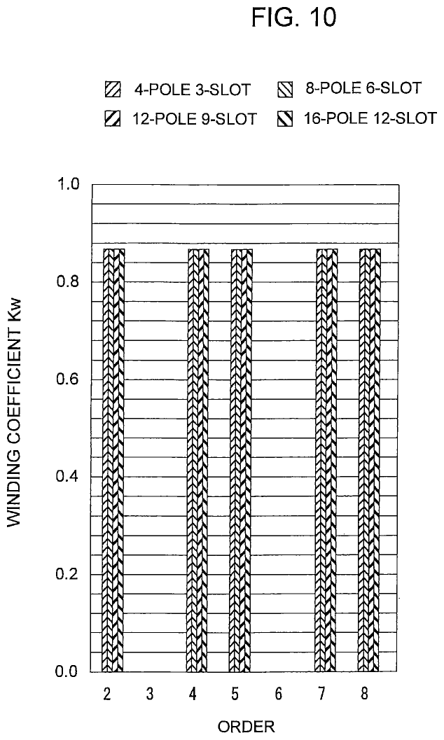

FIG. 10 is a graph showing the harmonic components of the inductive voltage in 4×M-pole 3×M-slot motors of the consequent-pole type. Specifically, FIG. 10 shows the harmonic components of the inductive voltage in 4-pole 3-slot, 8-pole 6-slot, 12-pole 9-slot and 16-pole 12-slot motors.

As shown in FIG. 10, in the 4×M-pole 3×M-slot motors, the winding coefficients Kw of the second, fourth, fifth, seventh and eighth order components are all great and are the same value. From this result, it is understood that the harmonic components of the inductive voltage are not reduced in the 4×M-pole 3×M-slot motors irrespective of the value of M.

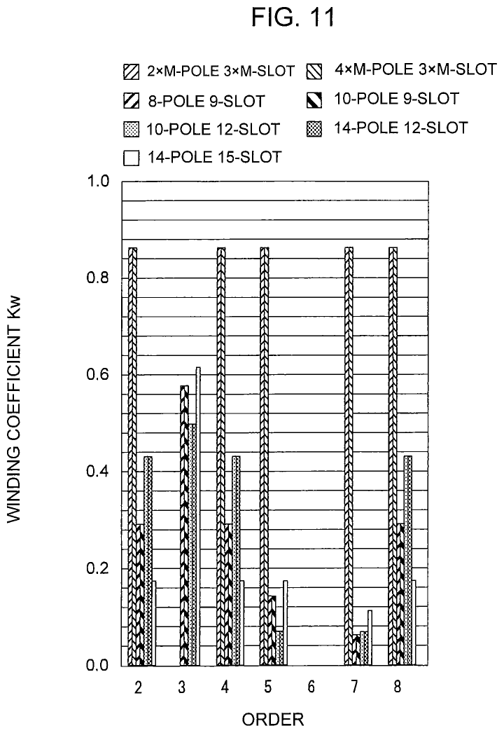

FIG. 11 is a graph showing the harmonic components of the inductive voltage in 8-pole 9-slot, 10-pole 9-slot, 10-pole 12-slot, 14-pole 12-slot and 14-pole 15-slot motors 10 of the consequent-pole type. These motors 10 fall under neither of the 2×M-pole 3×M-slot type and the 4×M-pole 3×M-slot type described above.

Further, FIG. 11 additionally shows the harmonic components of the inductive voltage in the 2×M-pole 3×M-slot motors (FIG. 9) and the 4×M-pole 3×M-slot motors of the consequent-pole type (FIG. 10).

As shown in FIG. 11, harmonic components other than the third order component are reduced in the 8-pole 9-slot, 10-pole 9-slot, 10-pole 12-slot, 14-pole 12-slot and 14-pole 15-slot motors 10 as compared to the 2×M-pole 3×M-slot motors and the 4×M-pole 3×M-slot motors.

Especially, the fifth order component and the seventh order component, which cause the noise, are reduced in the 8-pole 9-slot, 10-pole 9-slot, 10-pole 12-slot, 14-pole 12-slot and 14-pole 15-slot motors 10.

Namely, the harmonic components in the inductive voltage can be reduced by employing the motor 10 that falls under neither of the 2×M-pole 3×M-slot type and the 4×M-pole 3×M-slot type.

FIG. 12 is a graph showing comparison of the inductive voltage waveform between the 10-pole 12-slot motor 11 of the consequent-pole type and the 8-pole 12-slot (i.e., 2×M-pole 3×M-slot) motor of the consequent-pole type. As is clear from FIG. 12, the harmonic components are reduced and the inductive voltage waveform is sinusoidal in the 10-pole 12-slot motor 11 as compared to the 8-pole 12-slot motor.

The torque T of the motor 10 is proportional to the product (V×I) of the inductive voltage V caused by the linkage of the magnetic flux of the rotor 2 with the coil 55 and the current I flowing in the coil 55. Therefore, pulsation of the torque decreases with the decrease in the harmonic components of the inductive voltage. Accordingly, the noise of the motor 10 can be reduced.

In the torque pulsation of the motor 10, a component that principally leads to the increase in the noise is a sixth order component. This sixth order component of the torque pulsation is the most influenced by the fifth order component and the seventh order component of the inductive voltage. Thus, it is required to effectively reduce the fifth order component and the seventh order component of the inductive voltage.

The 8-pole 9-slot, 10-pole 9-slot, 10-pole 12-slot and 14-pole 12-slot motors 10 have great effect of reducing the fifth order component and the seventh order component of the inductive voltage, and thus have especially great effect of reducing the noise of the motor 10.

Meanwhile, when the motor 10 that falls under neither of the 2×M-pole 3×M-slot type and the 4×M-pole 3×M-slot type is employed, there is a problem in that an exciting force in the radial direction acting on the rotor 2 is likely to be large. The exciting force in the radial direction acting on the rotor 2 will be described below.

### Exciting Force in Radial Direction

FIG. 13 is a schematic diagram for explaining the exciting force in the radial direction acting on the rotor 2 (FIG. 1) of the 10-pole 12-slot motor 11. In the winding portions 55a respectively wound around two adjacent teeth 52 among the twelve teeth 52, currents of the same phase flow to cause magnetic fields in directions opposite to each other.

Among the winding portions 55a in which the U-phase current flows, the winding portions 55a wound counterclockwise as viewed from the rotor 2 side are regarded as being of a U-phase, and the winding portions 55a wound clockwise are regarded as being of a U-bar-phase. In the U-phase winding portions 55a and the U-bar-phase winding portions 55a, currents in opposite phases (in electric phases shifted from each other by 180 degrees) flow.

Similarly, among the winding portions 55a in which the V-phase current flows, the winding portions 55a wound counterclockwise as viewed from the rotor 2 side are regarded as being of a V-phase, and the winding portions 55a wound clockwise are regarded as being of a V-bar-phase. In the V-phase winding portions 55a and the V-bar-phase winding portions 55a, currents in opposite phases flow.

Among the winding portions 55a in which the W-phase current flows, the winding portions 55a wound counterclockwise as viewed from the rotor 2 side are regarded as being of a W-phase, and the winding portions 55a wound clockwise are regarded as being of a W-bar-phase. In the W-phase winding portions 55a and the W-bar-phase winding portions 55a, currents in opposite phases flow.

In the U-phase, V-phase and W-phase winding portions 55a, currents in phases electrically shifted from each other by 120 degrees flow. In this example, the winding portions 55a of the U-bar-phase, the U-phase, the W-phase, the W-bar-phase, the V-phase, the V-bar-phase, the U-phase, the U-bar-phase, the W-bar-phase, the W-phase, the V-phase and the V-bar-phase are wound around the twelve teeth 52 in the clockwise order in FIG. 13.

When the U-phase current flows in the winding portion 55a, the force in the radial direction indicated by the arrow F acts on the rotor 2 due to magnetic attraction force. Since the winding portions 55a in which the U-phase current flows are respectively situated on opposite sides of the axis C1, the forces in the radial direction acting on the rotor 2 cancel each other out. Namely, the exciting force in the radial direction that vibrates the rotor 2 in the radial direction is relatively small. The same goes for the V-phase current and the W-phase current.

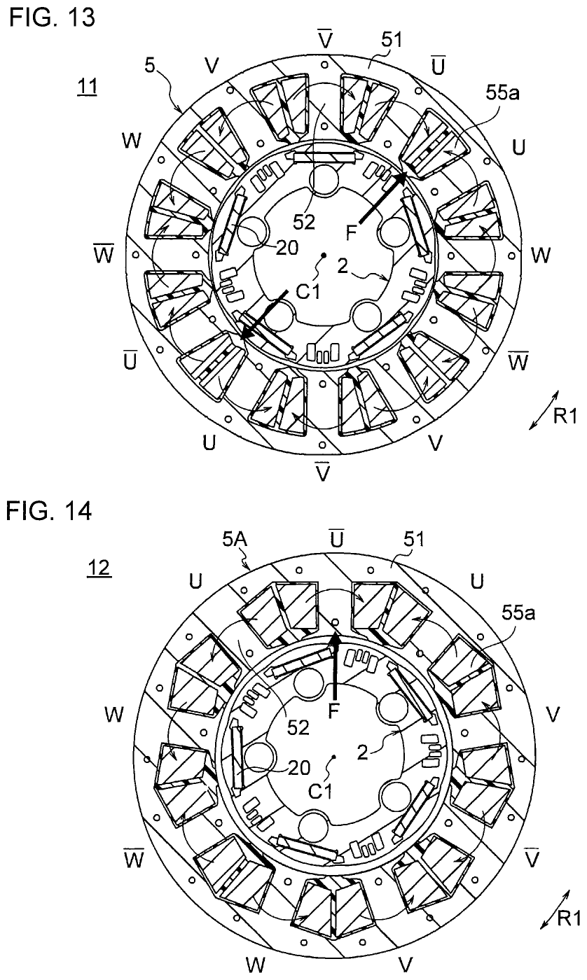

FIG. 14 is a schematic diagram for explaining the exciting force in the radial direction acting on the rotor 2 of the 10-pole 9-slot motor 12. The winding portions 55a of the U-phase, the U-bar-phase, the U-phase, the V-phase, the V-bar-phase, the V-phase, the W-phase, the W-bar-phase and the W-phase are wound around the nine teeth 52 in the clockwise order in FIG. 14.

The winding directions of the winding portions 55a of the U-phase, the U-bar-phase, the V-phase, the V-bar-phase, the W-phase and the W-bar-phase are as described above with reference to FIG. 13. The phase of the current flowing in the winding portion 55a of each phase is also as described above with reference to FIG. 13.

When the U-phase current flows in the winding portion 55a, the force in the radial direction indicated by the arrow F acts on the rotor 2 due to magnetic attraction force. Since the winding portions 55a in which the U-phase current flows are situated on one side of the axis C1, the exciting force in the radial direction is relatively large. The same goes for the V-phase current and the W-phase current.

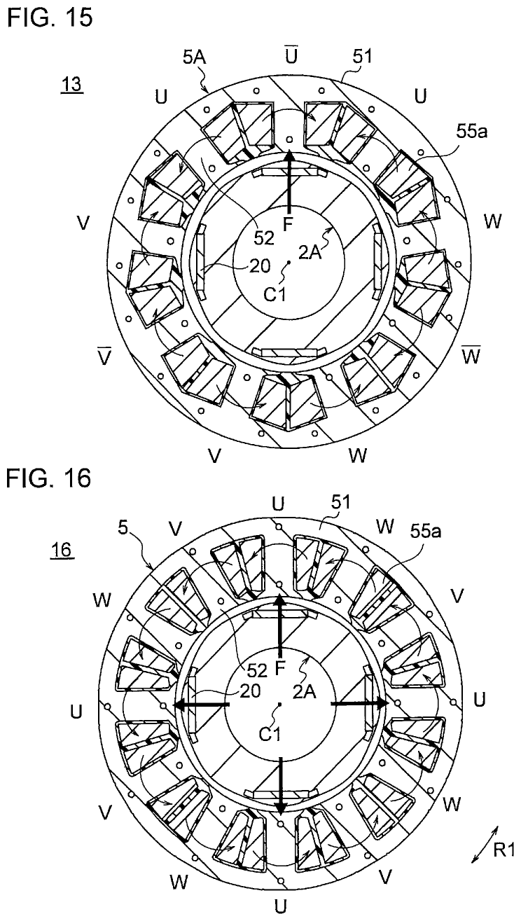

FIG. 15 is a schematic diagram for explaining the exciting force in the radial direction acting on the rotor 2A of the 8-pole 9-slot motor 13. Winding portions 55a of the U-phase, the U-bar-phase, the U-phase, the W-phase, the W-bar-phase, the W-phase, the V-phase, the V-bar-phase and the V-phase are wound around the nine teeth 52 in the clockwise order in FIG. 14.

The winding directions of the winding portions 55a of the U-phase, the U-bar-phase, the V-phase, the V-bar-phase, the W-phase and the W-bar-phase are as described above with reference to FIG. 13. The phase of the current flowing in the winding portion 55a of each phase is also as described above with reference to FIG. 13.

When the U-phase current flows in the winding portion 55a, the force in the radial direction indicated by the arrow F acts on the rotor 2A. Since the winding portions 55a in which the U-phase current flows are situated on one side of the axis C1, the exciting force in the radial direction is relatively large. The same goes for the V-phase current and the W-phase current.

In contrast, in the 2×M-pole 3×M-slot motors and the 4×M-pole 3×M-slot motors described above, the exciting force in the radial direction tends to be small.

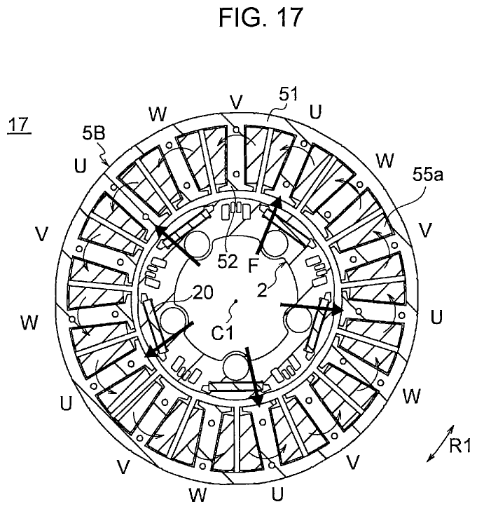

FIG. 16 is a schematic diagram for explaining the exciting force in the radial direction acting on the rotor 2A of the 8-pole 12-slot motor 16. The motor 16 includes the 8-pole rotor 2A described with reference to FIG. 4 and the 12-slot stator 5 described with reference to FIG. 1.

Around the twelve teeth 52 of the motor 16, the winding portions 55a of the U-phase, the W-phase, the V-phase, the U-phase, the W-phase, the V-phase, the U-phase, the W-phase, the V-phase, the U-phase, the W-phase and the V-phase are wound in the clockwise order in FIG. 16. The winding directions of the winding portions 55a of the U-phase, the V-phase and the W-phase are as described above with reference to FIG. 13. The phase of the current flowing in the winding portion 55a of each phase is also as described above with reference to FIG. 13.

When the U-phase current flows in the winding portion 55a, the force in the radial direction indicated by the arrow F acts on the rotor 2A. Since the winding portions 55a in which the U-phase current flows are arranged symmetrically around the axis C1, the exciting force in the radial direction is small. The same goes for the V-phase current and the W-phase current.

FIG. 17 is a schematic diagram for explaining the exciting force in the radial direction acting on the rotor 2 of the 10-pole 15-slot motor 17. The motor 17 includes the 10-pole rotor 2 described with reference to FIG. 1 and the 15-slot stator 5B described with reference to FIG. 6.

Around the fifteen teeth 52 of the motor 17, the winding portions 55a of the U-phase, the W-phase, the V-phase, the U-phase, the W-phase, the V-phase, the U-phase, the W-phase, the V-phase, the U-phase, the W-phase, the V-phase, the U-phase, the W-phase and the V-phase are wound in the clockwise order in FIG. 17. The winding directions of the winding portions 55a of the U-phase, the V-phase and the W-phase are as described above with reference to FIG. 13. The phase of the current flowing in the winding portion 55a of each phase is also as described above with reference to FIG. 13.

When the U-phase current flows in the winding portion 55a, the force in the radial direction indicated by the arrow F acts on the rotor 2. Since the winding portions 55a in which the U-phase current flows are arranged symmetrically around the axis C1, the exciting force in the radial direction is small. The same goes for the V-phase current and the W-phase current.

Among the five types of motors 11 to 13, 16 and 17 shown in FIG. 13 to FIG. 17, the motor in which the exciting force in the radial direction is the smallest is the 10-pole 15-slot motor 17 (FIG. 17), and the motor in which the exciting force in the radial direction is the second smallest is the 8-pole 12-slot motor 16 (FIG. 16). These motors 16 and 17 fall under the 2×M-pole 3×M-slot motors.

Conversely, the motor in which the exciting force in the radial direction is the largest is the 8-pole 9-slot motor 13 (FIG. 4), and the motor in which the exciting force in the radial direction is the second largest is the 10-pole 9-slot motor 12 (FIG. 3). The motor in which the exciting force in the radial direction is the third largest is the 10-pole 12-slot motor 11 (FIGS. 1 and 2).

In the following description, a configuration for inhibiting the noise due to the exciting force in the radial direction will be described. The noise of the blower 1 occurs notably at cycles corresponding to integral multiples of the number N of blades 81 of the fan unit 8. Therefore, it is necessary to prevent the cycle of the above-described exciting force in the radial direction in the motor 10 from coinciding with a vibration cycle of the blower 1.

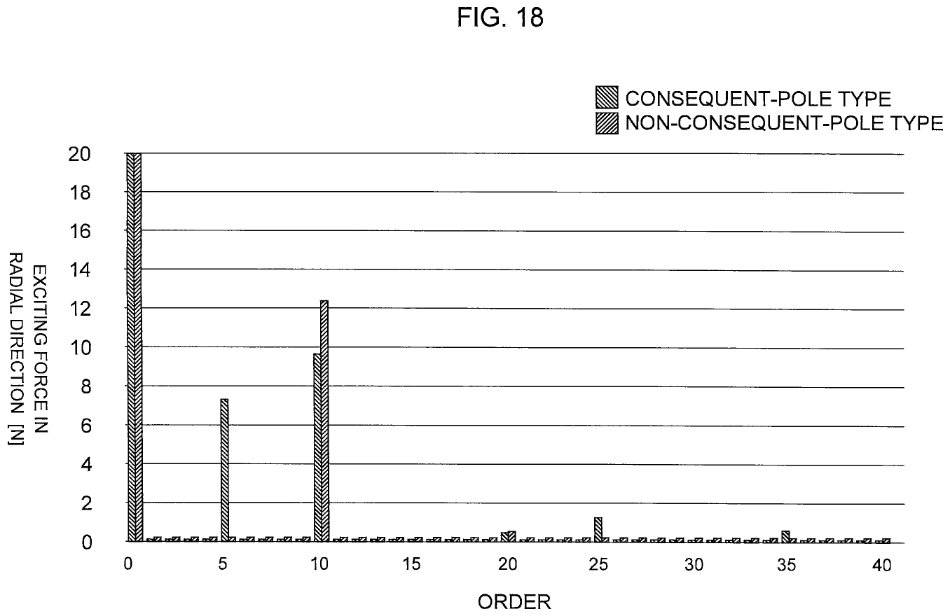

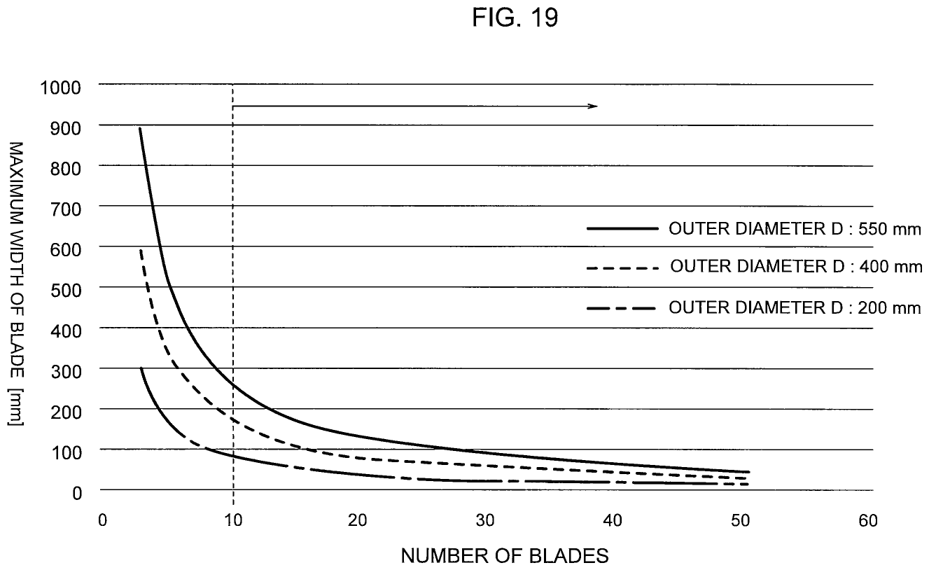

FIG. 18 is a graph showing a frequency analysis result of the exciting force in the radial direction in the motor 10 of the consequent-pole type and the motor of the non-consequent-pole type. The number of magnetic poles is 10 in each motor. In the frequency analysis, the rotor 2 is decentered so that the exciting force in the radial direction appears notably.

As is clear from FIG. 18, the exciting force in the radial direction in the motor of the non-consequent-pole type includes frequency components which are integral multiples of 10 as the magnetic pole number. In contrast, the exciting force in the radial direction in the motor of the consequent-pole type includes frequency components which are integral multiples of 5 as ½ of the magnetic pole number. This is for the reason described below.

In the motor of the non-consequent-pole type, the force acting between the north pole and the stator and the force acting between the south pole and the stator are equal to each other, and thus variation in the exciting force in the radial direction occurs every rotation of each magnetic pole.

In contrast, in the motor of the consequent-pole type, the force acting between the magnet magnetic pole as the north pole and the stator and the force acting between the virtual magnetic pole as the south pole and the stator differ from each other, and thus variation in the exciting force in the radial direction occurs every rotation of a portion including each pair of the magnet magnetic pole and the virtual magnetic pole.

Based on this result, in this embodiment, the number N of blades 81 of the fan unit 8 is set at an integer other than integral multiples of ½ of the number P of magnetic poles so as to prevent the cycle of the exciting force in the radial direction of the motor 10 from coinciding with the vibration cycle of the blower 1.

Next, a lower limit and an upper limit of the number N of blades 81 will be described. When the number N of blades 81 is one, the center of gravity of the fan unit 8 cannot be situated on the axis C1 and noise occurs when the fan unit 8 rotates. Thus, the lower limit of the number N of blades 81 is 2.

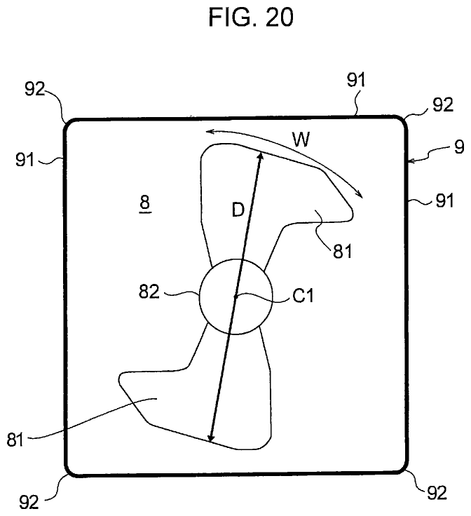

Further, as the number N of blades 81 increases, the width of each of the blades 81 that can be attached to the shaft 28 decreases. FIG. 19 is a graph showing a relationship between the number of blades 81 and a maximum width W (see FIG. 20) of each of the blades 81 that can be attached to the shaft 28.

In this example, the maximum widths W in cases where the outer diameter D of the blades 81 (see FIG. 20) is 200 mm, 400 mm and 550 mm are shown. The blades 81 are attached to the shaft 28 so that the blades 81 are arranged in the circumferential direction. The maximum width W (see FIG. 20) of the blade 81 is a maximum length of the blade 81 in the circumferential direction.

As shown in FIG. 19, in each of the cases where the outer diameter D of the blades 81 is 200 mm, 400 mm and 550 mm, the maximum width W of the blade 81 extremely decreases when the number N of blades 81 exceeds 10. As the width of the blade 81 decreases, it becomes difficult to secure sufficient strength against a centrifugal force occurring when the blade 81 rotates or an external force due to air blown onto the blade 81.

Thus, in this embodiment, the upper limit of the number N of blades 81 of the fan unit 8 is set at 10 in order to secure sufficient strength of the blades 81.

Based on the above results, in this embodiment, the number N of blades 81 of the fan unit 8 is set at an integer greater than or equal to 2 and less than or equal to 10 excluding integral multiples of ½ of the number P of magnetic poles.

When the 10-pole motor 11 or 12 (FIG. 1 or 3) is employed, the number N of blades 81 of the fan unit 8 is set at an integer greater than or equal to 2 and less than or equal to 10 excluding integral multiples of 5 as ½ of the number P of magnetic poles.

When the 8-pole motor 13 (FIG. 4) is employed, the number N of blades 81 of the fan unit 8 is set at an integer greater than or equal to 2 and less than or equal to 10 excluding integral multiples of 4 as ½ of the number P of magnetic poles.

When the 14-pole motor 14 or 15 (FIG. 5 or 6) is employed, the number N of blades 81 of the fan unit 8 is set at an integer greater than or equal to 2 and less than or equal to 10 excluding integral multiples of 7 as ½ of the number P of magnetic poles.

For example, by setting the number N of blades 81 at 2 or 3, the noise of the blower 1 can be inhibited in any one of the cases where the number P of magnetic poles is 10 (FIGS. 1 and 3), 8 (FIGS. 4) and 14 (FIGS. 5 and 6).

FIG. 20 is a diagram showing the fan unit 8 including two blades 81 as viewed from a side opposite to the motor 10 (FIG. 7) in the axial direction. The two blades 81 are provided at two positions symmetrical with each other with respect to the axis C1.

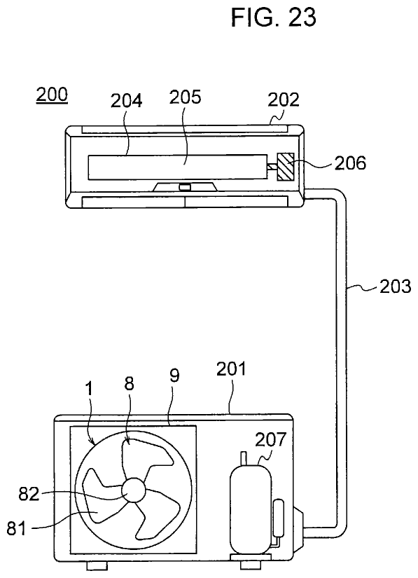

The fan unit 8 is accommodated in an accommodation portion 9. The accommodation portion 9 is, for example, an accommodation chamber provided in an outdoor unit 201 (FIG. 23) of an air conditioner 200. The accommodation portion 9 has a quadrangular shape in a plane orthogonal to the axial direction. More specifically, the accommodation portion 9 includes four wall portions 91 surrounding the fan unit 8 on all four sides. A corner portion 92 is formed between adjoining wall portions 91.

The accommodation portion 9 may be either a portion that accommodates the fan unit 8 alone or a portion that accommodates both of the fan unit 8 and the motor 10.

Since the two blades 81 of the fan unit 8 are arranged at two positions symmetrical with each other with respect to the axis C1, the center of gravity of the fan unit 8 is situated on the axis C1. Accordingly, the noise when the fan unit 8 rotates can be inhibited.

As described above, the lower limit of the number N of blades 81 is 2 since the center of gravity of the fan unit 8 cannot be situated on the axis C1 when the number N of blades 81 is 1. By setting the number N of blades 81 to 2, it is possible to maximize the width W of each blade 81 and thereby increase the strength of the blades 81.

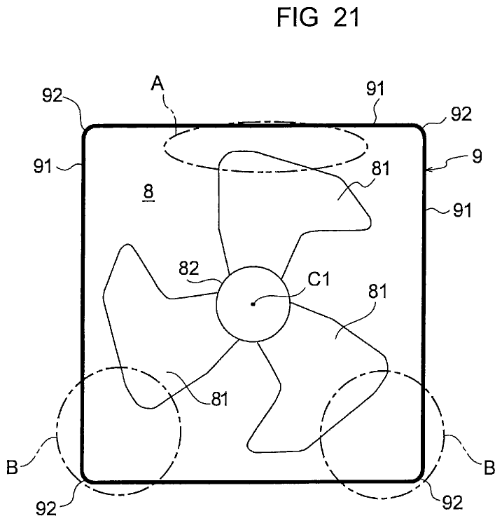

FIG. 21 is a diagram showing the fan unit 8 including three blades 81. The three blades 81 are provided at 120-degree intervals around the axis C1. The fan unit 8 is accommodated in the accommodation portion 9 described above with reference to FIG. 20.

As described above with reference to FIG. 11, in the 8-pole 9-slot, 10-pole 9-slot, 10-pole 12-slot, 14-pole 12-slot and 14-pole 15-slot motors 10, the third order winding coefficient is relatively large. Namely, the third order harmonic component occurs in the inductive voltage.

When the third order harmonic component occurs in the inductive voltage, the second order component or the fourth order component occurs in the torque pulsation. Since the noise occurs notably at cycles corresponding to integral multiples of the number N of blades 81, the noise may increase when the number of blades 81 is set at an integral multiple of 2 or an integral multiple of 4.

Thus, the increase in the noise can be inhibited by setting the number N of blades 81 at 3which is neither an integral multiple of 2 nor an integral multiple of 4.

Further, the smallest integer which is neither an integral multiple of 2 nor an integral multiple of 4 is 3. Therefore, by setting the number of blades 81 at 3, it is possible to maximize the width W of each blade 81 and thereby increase the strength of the blades 81.

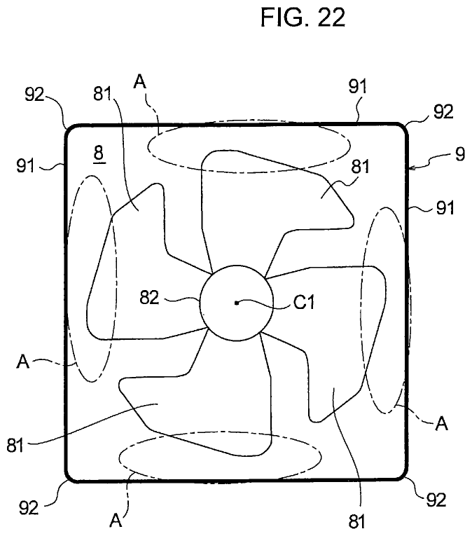

FIG. 22 is a diagram showing the fan unit 8 including four blades 81. The four blades 81 are provided at 90-degree intervals around the axis C1. The fan unit 8 is accommodated in the accommodation portion 9 described above with reference to FIG. 20.

Since the fan unit 8 includes four blades 81 and the accommodation portion 9 includes four wall portions 91, the timing when the blade 81 and the wall portion 91 get closest to each other is the same for all of the four blades 81 as indicated by the reference character A in FIG. 22. Accordingly, phases of the four blades 81 with respect to the corresponding wall portions 91 are the same as each other, which may increase the noise.

In contrast, in the fan unit 8 including three blades 81 shown in FIG. 21, even when one blade 81 is the closest to the wall portion 91 (reference character A), the other blades 81 are facing the corner portions 92 (reference character B). Since the phases of the three blades 81 with respect to their corresponding wall portions 91 are not the same, the increase in the noise can be inhibited.

### Air Conditioner

Next, an air conditioner 200 employing the motor 10 in the first embodiment will be described. FIG. 23 is a diagram showing the configuration of the air conditioner 200. The air conditioner 200 includes an outdoor unit 201, an indoor unit 202, and a refrigerant pipe 203 connecting the outdoor unit 201 and the indoor unit 202 together.

The outdoor unit 201 includes the blower 1 as an outdoor blower. The configuration of the blower 1 is as described above with reference to FIG. 7. Incidentally, FIG. 23 also shows a compressor 207 that compresses a refrigerant.

The indoor unit 202 includes an indoor blower 204. The indoor blower 204 includes an impeller 205 and a motor 206 for driving the impeller 205. The indoor blower 204 is a cross-flow fan, for example.

In the blower 1 as the outdoor blower, the rotation of the rotor 2 of the motor 10 causes the blades 81 to rotate and blow air to a heat exchanger not illustrated. In a cooling operation of the air conditioner 200, heat emitted when the refrigerant compressed by the compressor 207 is condensed in the heat exchanger (condenser) is discharged to the outside of the room by the air blowing by the blower 1.

In the indoor blower 204, the rotation of the rotor of the motor 206 causes the impeller 205 to rotate and blow air to the inside of the room. In the cooling operation of the air conditioner 200, air deprived of heat when the refrigerant is evaporated in an evaporator (not shown) is blown to the inside of the room by the air blowing by the indoor blower 204.

Since the motor 10 in this embodiment makes little noise, it is possible to enhance quietness of the outdoor unit 201 including the blower 1 and thereby enhance the quietness of the air conditioner 200.

While the blower 1 (FIG. 7) is used as the outdoor blower of the outdoor unit 201 in this example, it is also possible to use the blower 1 as the indoor blower 204 of the indoor unit 202.

### Effects of Embodiment

As described above, the blower 1 in the first embodiment includes the rotor 2 including the magnet magnetic poles P1 and the virtual magnetic poles P2 in the circumferential direction. The number of magnetic poles including the magnet magnetic poles P1 and the virtual magnetic poles P2 is P. The blower 1 includes the stator 5 surrounding the rotor 2 from outside in the radial direction and including S slots arranged in the circumferential direction, and N blades 81 attached to the shaft 28 of the rotor 2 and arranged in the circumferential direction. The combination of the number P of magnetic poles and the number S of slots of the motor 10 is one of 8-pole 9-slot (P=8 and S=9), 10-pole 9-slot (P=10 and S=9), 10-pole 12-slot (P=10 and S=12) and 14-pole 12-slot (P=14 and S=12). The number N of blades 81 is an integer greater than or equal to 2 and less than or equal to 10 excluding integral multiples of P/2.

Since the motor 10 is one of 8-pole 9-slot, 10-pole 9-slot, 10-pole 12-slot and 14-pole 12-slot motors, the harmonic components of the inductive voltage can be reduced and the noise of the motor 10 can be reduced as compared to the 2×M-pole 3×M-slot motors and the 4×M-pole 3×M-slot motors. Further, since the number N of blades 81 is an integer greater than or equal to 2 and less than or equal to 10 excluding integral multiples of P/2, the cycle of the exciting force in the radial direction of the motor 10 can be prevented from coinciding with the vibration cycle of the blower 1. Thus, the noise when the blades 81 rotate can be inhibited.

Especially, by employing the 10-pole 12-slot motor 11, the fifth order harmonic component of the inductive voltage can be reduced most effectively (see FIG. 11). Accordingly, the sixth order component of the torque pulsation of the motor 11 can be reduced and the noise reduction effect can be enhanced. Further, in the 10-pole 12-slot motor 11, the winding portions 55a in which currents of the same phase flow can be arranged symmetrically with respect to the axis C1, and thus the exciting force in the radial direction can be reduced. Furthermore, the noise when the blades 81 rotate can be inhibited by setting the number N of blades 81 at an integer greater than or equal to 2 and less than or equal to 10 excluding integral multiples of 5.

By employing the 10-pole 9-slot motor 12, the seventh order harmonic component of the inductive voltage can be reduced most effectively (see FIG. 11). Accordingly, the sixth order component of the torque pulsation of the motor 12 can be reduced and the noise reduction effect can be enhanced. Further, the noise when the blades 81 rotate can be inhibited by setting the number of blades 81 at an integer greater than or equal to 2 and less than or equal to 10 excluding integral multiples of 5.

By employing the 8-pole 9-slot motor 13, the seventh order harmonic component of the inductive voltage can be reduced most effectively (see FIG. 11). Accordingly, the sixth order component of the torque pulsation of the motor 13 can be reduced and the noise reduction effect can be enhanced. Further, the noise when the blades 81 rotate can be inhibited by setting the number of blades 81 at an integer greater than or equal to 2 and less than or equal to 10 excluding integral multiples of 4.

By employing the 14-pole 12-slot motor 14, the fifth order harmonic component of the inductive voltage can be reduced most effectively (see FIG. 11). Accordingly, the sixth order component of the torque pulsation of the motor 14 can be reduced and the noise reduction effect can be enhanced. Further, the noise when the blades 81 rotate can be inhibited by setting the number of blades 81 at an integer greater than or equal to 2 and less than or equal to 10 excluding integral multiples of 7.

By setting the number N of blades 81 at an odd number, the increase in the noise can be inhibited even when the second order or fourth order component occurs in the torque pulsation due to the third order harmonic component of the inductive voltage.

Further, since the number N of blades 81 is 2 or 3, a sufficient length in the circumferential direction of the blade 81 can be secured and the strength of the blade 81 can be increased while also reducing the noise.

Furthermore, since the fan unit 8 is accommodated in the accommodation portion 9 in a quadrangular shape in a plane orthogonal to the axial direction and the number N of blades 81 is an integer greater than or equal to 2 and less than or equal to 10 excluding integral multiples of 4, the phase between each blade 81 and the corresponding wall portion 91 of the accommodation portion 9 can be made different from each other and the noise can be reduced.

Moreover, since the motor 10 includes the mold resin portion 60 that surrounds the stator 5 from outside in the radial direction, the vibration of the motor 10 itself can be inhibited and the noise can be reduced further.

The blower 1 described in the first embodiment can be installed also in electric equipment other than the blower of the air conditioner, such as a ventilating fan.

While each motor 10 described here is an IPM (Interior Permanent Magnet) motor in which permanent magnets 25 are embedded in the rotor 2, the motor 10 may also be an SPM (Surface Permanent Magnet) motor in which permanent magnets 25 are attached to the surface of the rotor 2.

While the preferred embodiment of the present disclosure has been described specifically above, the present disclosure is not limited to the above-described embodiment and a variety of improvements or modifications may be made within the scope not departing from the subject matter of the present disclosure.

1. A blower comprising:
a rotor that includes a shaft, a rotor core in an annular shape about at a central axis of the shaft, and permanent magnets attached to the rotor core, the permanent magnets forming magnet magnetic poles, portions of the rotor core forming virtual magnetic poles, and a number of magnetic poles comprising the magnet magnetic poles and the virtual magnetic poles being P;
a stator that surrounds the rotor from outside in a radial direction about the central axis and has S slots arranged in a circumferential direction about the central axis; and
N blades that are attached to the shaft and arranged in the circumferential direction,
wherein the number P of magnetic poles is 8, the number S of slots is 9, and the number N of blades is an integer greater than or equal to 2 and less than or equal to 10 excluding integral multiples of 4, or
wherein the number P of magnetic poles is 14, the number S of slots is 12, and the number N of blades is an integer greater than or equal to 2 and less than or equal to 10 excluding integral multiples of 7.

2-5. (canceled)

6. The blower according to claim 1, wherein the number N of blades is an odd number.

7. The blower according to claim 1, wherein the number N of blades is 2 or 3.

8. The blower according to claim 1, wherein the blades are accommodated in an accommodation portion in a quadrangular shape in a plane orthogonal to a direction of the central axis, and
wherein the number N of blades is an integer greater than or equal to 2 and less than or equal to 10 excluding integral multiples of 4.

9. The blower according to claim 1, wherein the rotor core has magnet insertion holes, and wherein the permanent magnets are inserted in the magnet insertion holes.

10. The blower according to claim 1, comprising a mold resin portion that surrounds the stator from outside in the radial direction.

11. An air conditioner comprising an outdoor unit and an indoor unit connected to the outdoor unit by refrigerant piping,
wherein at least one of the outdoor unit and the indoor unit includes the blower according to claim 1.
